(19) United States
(12) Patent Application Publication
(10) Pub. No.: US 2026/0145840 A1
(43) Pub. Date: May 28, 2026

(54) TOOL KIT WITH LOCKING MECHANISMS

(71) Applicant: DURATEC TOOLS LTD., SUZHOU (CN)

(72) Inventor: Hanguang Yan, Qingdao (CN)

(21) Appl. No.: 19/398,488

(22) Filed: Nov. 24, 2025

(30) Foreign Application Priority Data
Nov. 28, 2024 (CN) 202411724023.7

(51) Int. Cl. B65D 21/02; B25H 3/02

(52) U.S. Cl. CPC B65D 21/0223; B25H 3/023

(57) ABSTRACT

The present invention discloses a tool kit with locking mechanisms. The tool kit comprises a kit body, locking grooves are provided on one side surface of the kit body, the locking mechanisms are provided on the other side surface, and the locking mechanisms comprise unlocking members and locking fasteners that are connected to each other; and when multiple tool kits are stacked and when the unlocking members are in a locked position state, locking fasteners of one of the tool kits are clamped into locking grooves of another one of the tool kits. According to the locking mechanisms of the present invention, unlocking can be achieved by only pulling the unlocking members upward to drive the locking fasteners to be detached from the locking grooves, an unlocking method is simple, and operations are convenient.

### CROSS-REFERENCE TO RELATED APPLICATIONS

The present application is a Continuation in part of Chinese Patent Application No. 202411724023.7, filed on Nov. 28, 2024.

### TECHNICAL FIELD

The present invention belongs to the technical field of tool kit storage equipment, and particularly relates to a tool kit with locking mechanisms.

### BACKGROUND

In current production and life, tool kits are one of necessary industrial products, and internal storage spaces can store a variety of tools to facilitate storage and use. When there are many tool kits, the tool kits usually need to be stacked for storage to reduce an occupied space.

For example, Chinese utility model patent CN208391993U discloses a set of stacked tool kits, which comprises kit bodies. The kit bodies are stacked by fixed buckle portions and movable buckle portions. During the use, by rotating the movable buckle portions of the kit body below, the movable buckle portions are vertical. At this time, buckle grooves of the movable buckle portions are buckled with the fixed buckle portions of the kit body above, and end portions of lock heads in the movable buckle portions are exactly embedded in grooves in the middles of rotating shafts. At this time, the two kit bodies stacked up and down are connected into a whole. However, this stacking and connection method is prone to external collisions to cause failed stacking and connection, thus having poor structural stability.

### SUMMARY

An objective of the present invention is to provide a tool kit with locking mechanisms to solve the above technical problems put forward in the background art.

To achieve the above objective, the present invention discloses a tool kit with locking mechanisms, which comprises a kit body, wherein locking grooves are provided on one side surface of the kit body, the locking mechanisms are provided on the other side surface of the kit body, and the locking mechanisms comprise unlocking members and locking fasteners that are connected to each other;
when multiple tool kits are stacked and when the unlocking members are in a locked position state, locking fasteners of one of the tool kits are clamped into locking grooves of another one of the tool kits; and when the unlocking members are in an unlocked position state, the locking fasteners of the one of the tool kits are detached from the locking grooves of the another one of the tool kits.

Specifically, the locking fasteners are snapped into the locking grooves and are clamped into the locking grooves in the form of pressure application, and tool kits are interlocked at this time; and the locking fasteners are acted in the form of force application and pulling to drive the locking fasteners to be detached from the locking grooves, the locking fasteners are unlocked at this time, and the tool kits are separated.

Further, a groove is provided on an upper surface of the kit body, and the locking grooves are provided on edges of the groove; protrusions are provided on a lower surface of the kit body, and sizes of outer side edges of the protrusions are smaller than those of inner side edges of the groove; the locking mechanisms are provided on edges of the protrusions, and the locking fasteners are provided at lower portions of the locking mechanisms; and when multiple tool kits are stacked, the protrusions of the tool kit above are placed in the groove of the tool kit below, and the locking fasteners of the tool kit above are clamped into the locking grooves of the tool kit below.

Further, the locking mechanisms further comprise rotating shafts, first elastic members, and second elastic members;
locking mechanism mounting grooves are provided on the edges of the protrusions, and first elastic member mounting grooves and second elastic member mounting grooves are provided in the locking mechanism mounting grooves;
first elastic member sleeve columns are provided above the unlocking members, the first elastic members are sleeved on the first elastic member sleeve columns, the first elastic members are movably placed in the first elastic member mounting grooves,
second elastic member sleeve columns are provided on the locking fasteners, the second elastic members are sleeved on the second elastic member sleeve columns, and the second elastic members are movably placed in the second elastic member mounting grooves;
the first elastic member mounting grooves are located above the locking mechanism mounting grooves in a vertical direction, and the second elastic member mounting grooves are located below the locking mechanism mounting grooves in a horizontal direction;
locking and unlocking portions are provided on both left and right side surfaces of the unlocking members, the locking and unlocking portions comprise first convex edges and second convex edges that are provided from bottom to top along the side surfaces of the unlocking members, the first convex edges are horizontally provided, and the second convex edges are obliquely provided upward; areas defined by back surfaces and side surfaces of the unlocking members, the first convex edges, and the second convex edges are the locking and unlocking portions;
inner sides of upper portions of the locking fasteners are clamped and mounted into the locking and unlocking portions through locking and unlocking shafts, outer sides of middle portions of the locking fasteners are rotatably mounted in the locking mechanism mounting grooves through the rotating shafts, and locking buckle hooks are integrally formed at lower portions of the locking fasteners; the locking and unlocking shafts and the rotating shafts are both 2 in number and are each respectively located symmetrically on left and right sides of the locking fasteners; and
the middle portions to the upper portions of the locking fasteners are obliquely provided upward and are consistent with inclination directions of the first convex edges, and distances between the rotating shafts and back surfaces of the locking fasteners are greater than distances between the locking and unlocking shafts and the back surfaces of the locking fasteners.

Further, front surfaces of the unlocking members are provided with push grooves above the locking and unlocking portions.

Further, the second elastic member sleeve columns are 2 in number and are respectively located below the 2 locking and unlocking shafts.

Further, the locking mechanisms and the locking grooves are the same in number and are both 1 or more in number.

Further, in the groove on the upper surface of the kit body, clamping grooves are provided inside one side opposite to the locking grooves; and clamping blocks are provided on the edges of the protrusions on the lower surface of the kit body, and the clamping blocks and the clamping grooves are both matched in size and position.

Further, the clamping grooves and the clamping blocks are the same in number and are both more than 2 in number.

Further, the locking mechanisms are located on one side of an opening of the tool kit.

Further, a cocking groove is provided on a side edge of the tool kit.

Compared with the prior art, the tool kit with locking mechanisms of the present invention has the following advantages:

According to the tool kit of the present invention, the locking fasteners are clamped into the locking grooves in the form of pressure application to achieve interlocking between tool kits, and the locking fasteners are detached from the locking grooves in the form of force application and pulling for unlocking. Compared with an existing locking fastener structure which has a locking and unlocking method of rotating around a rotating shaft, the tool kit can be firmly locked when being stacked, is not prone to slipping, has a simple and stable unlocking method, and is convenient to operate.

### BRIEF DESCRIPTION OF THE DRAWINGS

FIG. 1 is a first three-dimensional structural schematic diagram of a tool kit with locking mechanisms.

FIG. 2 is a three-dimensional structural schematic diagram of two stacked tool kits of different sizes.

FIG. 3 is an enlarged view of region A in FIG. 1.

FIG. 4 is an enlarged view of region B in FIG. 1.

FIG. 5 is a second three-dimensional structural schematic diagram of the tool kit with locking mechanisms.

FIG. 6 is an enlarged view of region C in FIG. 5.

FIG. 7 is a third three-dimensional structural schematic diagram of the tool kit with locking mechanisms.

FIG. 8 is an enlarged view of region D in FIG. 7.

FIG. 9 is an exploded view of a locking mechanism.

FIG. 10 is a partial sectional view of the tool kit in a stacked state.

FIG. 11 is a sectional view of the locking mechanism at the beginning of unlocking.

FIG. 12 is a sectional view of the locking mechanism during an unlocking process.

FIG. 13 is a sectional view of the locking mechanism at the end of unlocking.

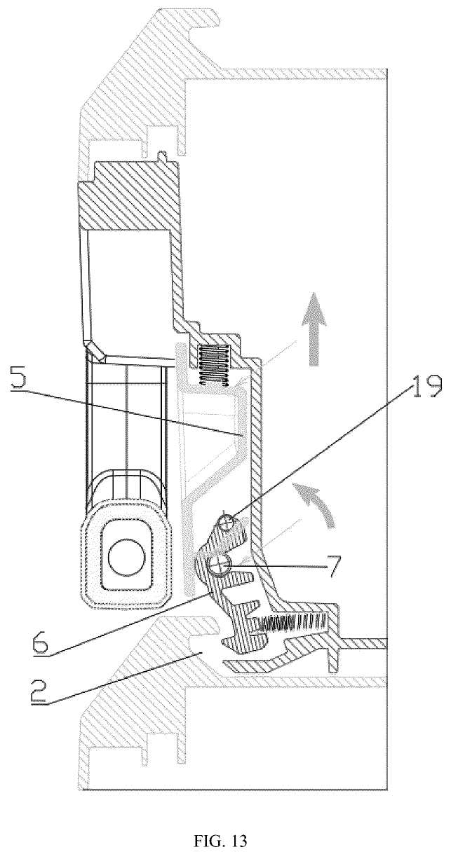

In the figures, 1. groove; 2. locking groove; 3. protrusion; 4. locking mechanism; 5. unlocking member; 6. locking fastener; 7. rotating shaft; 8. locking buckle hook; 9. first elastic member; 10. second elastic member; 11. locking mechanism mounting groove; 12. first elastic member mounting groove; 13. second elastic member mounting groove; 14. first elastic member sleeve column; 15. second elastic member sleeve column; 16. locking and unlocking portion; 17. first convex edge; 18. second convex edge; 19. locking and unlocking shaft; 20. push groove; 21. clamping groove; 22. clamping block; 23. handle placement groove; 24. foldable handle; 25. cocking groove.

### DESCRIPTION OF EMBODIMENTS

The tool kit with locking mechanisms of the present invention is described in detail below in conjunction with the drawings.

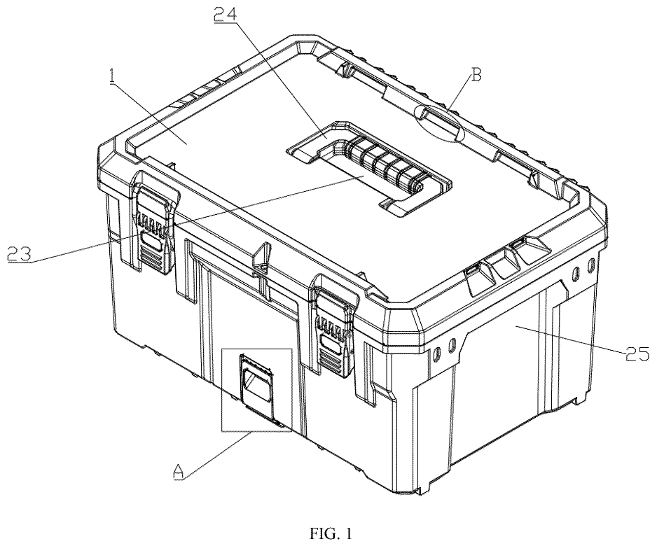

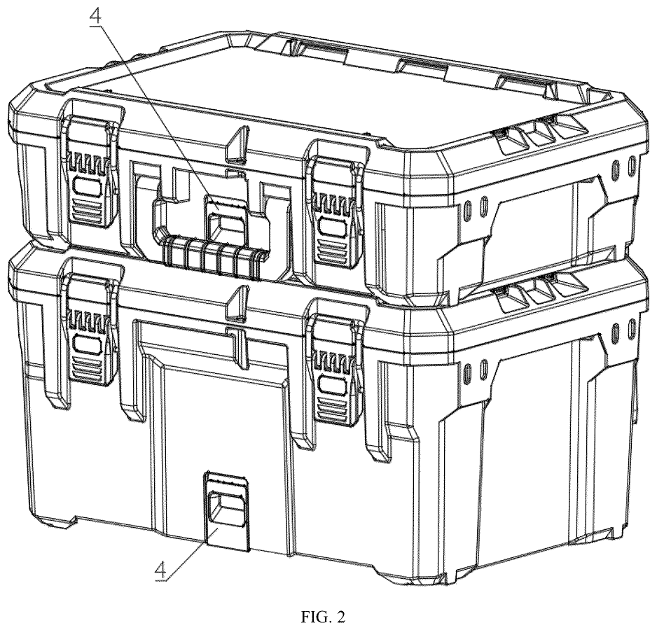

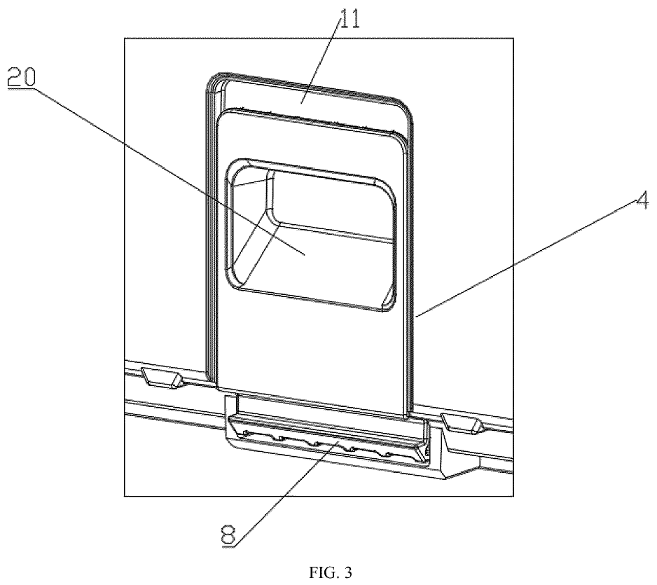

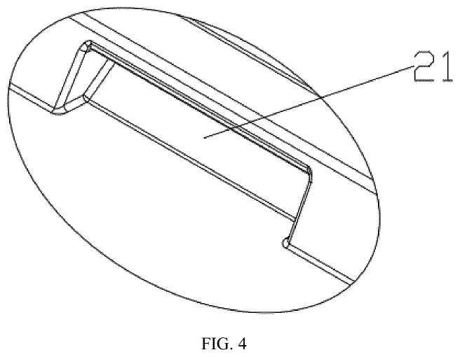

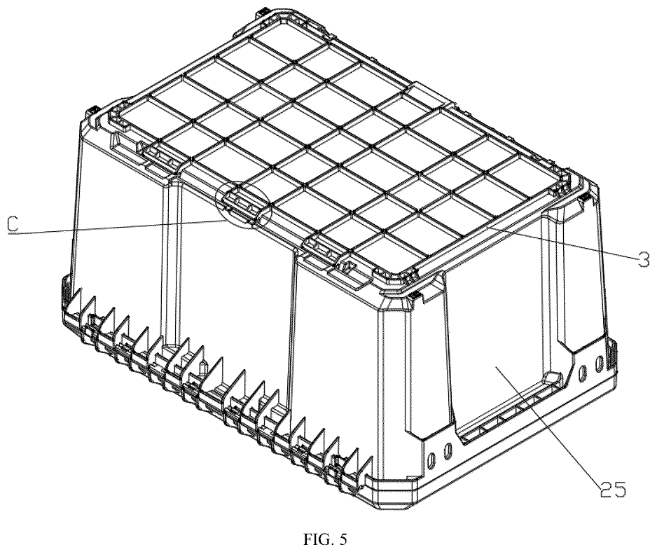

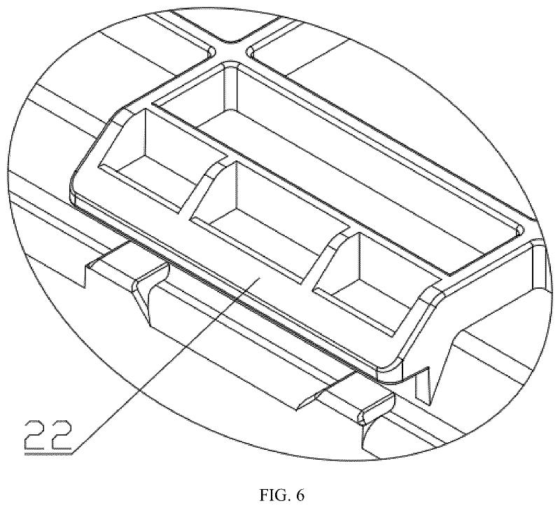

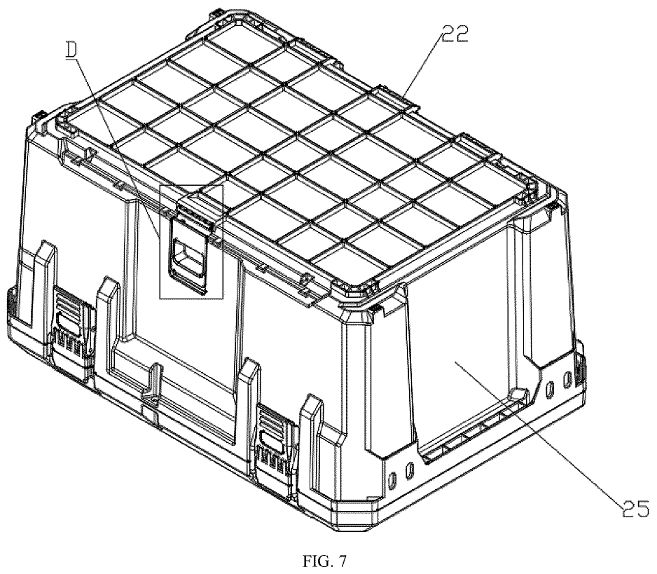

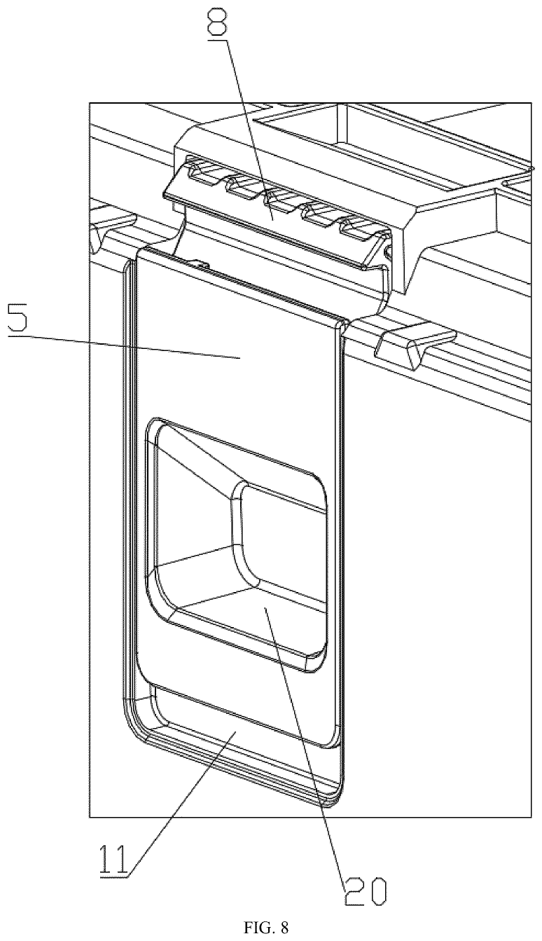

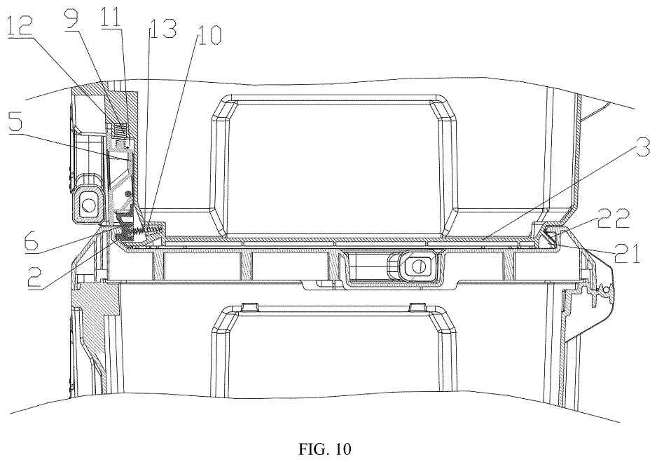

As shown in FIG. 1-FIG. 10, structural schematic diagrams of the tool kit with locking mechanisms are given.

In the tool kit with locking mechanisms, a groove 1 is provided on an upper surface of a kit body, locking grooves 2 are provided on edges of the groove 1, protrusions 3 are provided on a lower surface of the kit body, and sizes of outer side edges of the protrusions 3 are smaller than those of inner side edges of the groove 1; the locking mechanisms 4 are provided on edges of the protrusions 3, and locking buckle hooks 8 are provided at lower portions of the locking mechanisms 4; and
when tool kits are stacked, protrusions 3 of a tool kit above is placed in a groove 1 of a tool kit below, and locking buckle hooks 8 of the tool kit above are clamped into locking grooves 2 of the tool kit below.

Specifically, the locking mechanisms 4 comprise unlocking members 5, locking fasteners 6, rotating shafts 7, first elastic members 9, and second elastic members 10, wherein the first elastic members 9 and the second elastic members 10 are both springs.

Locking mechanism mounting grooves 11 are provided on the edges of the protrusions 3, and first elastic member mounting grooves 12 and second elastic member mounting grooves 13 are provided in the locking mechanism mounting grooves 11;
first elastic member sleeve columns 14 are provided above the unlocking members 5, the first elastic members 9 are sleeved on the first elastic member sleeve columns 14, and the first elastic members 9 are movably placed in the first elastic member mounting grooves 12; second elastic member sleeve columns 15 are provided on the locking fasteners 6, the second elastic members 10 are sleeved on the second elastic member sleeve columns 15, and the second elastic members 10 are movably placed in the second elastic member mounting grooves 13; and the first elastic member mounting grooves 12 are located above the locking mechanism mounting grooves 11 in a vertical direction, and the second elastic member mounting grooves 13 are located below the locking mechanism mounting grooves 11 in a horizontal direction.

Locking and unlocking portions 16 are provided on both left and right side surfaces of the unlocking members 5, the locking and unlocking portions 16 comprise first convex edges 17 and second convex edges 18 that are provided from bottom to top along the side surfaces of the unlocking members 5, the first convex edges 17 are horizontally provided, and the second convex edges 18 are obliquely provided upward; areas defined by back surfaces and side surfaces of the unlocking members 5, the first convex edges 17, and the second convex edges 18 are the locking and unlocking portions 16; and to conveniently push the unlocking members 5, front surfaces of the unlocking members 5 are provided with push grooves 20 above the locking and unlocking portions 16, and the first elastic member sleeve columns 14 are provided above outer portions of the push grooves 20.

Inner sides of upper portions of the locking fasteners 6 are clamped and mounted into the locking and unlocking portions 16 through locking and unlocking shafts 19, the locking and unlocking shafts 19 are integrally formed with the upper portions of the locking fasteners 6, outer sides of middle portions of the locking fasteners 6 are rotatably mounted in the locking mechanism mounting grooves 11 through the rotating shafts 7, and the locking buckle hooks 8 are integrally formed at lower portions of the locking fasteners 6; the locking and unlocking shafts 19 and the rotating shafts 7 are both 2 in number and are each respectively located symmetrically on left and right sides of the locking fasteners 6; and
correspondingly, to improve a locking effect, the second elastic member sleeve columns 15 are also provided with 2 in number and are respectively located below the 2 locking and unlocking shafts 19.

The middle portions to the upper portions of the locking fasteners 6 are obliquely provided upward and are consistent with inclination directions of the first convex edges 17, and distances between the rotating shafts 7 and back surfaces of the locking fasteners 6 are greater than distances between the locking and unlocking shafts 19 and the back surfaces of the locking fasteners 6.

The locking mechanisms 4 and the locking grooves 2 are provided in pairs and are equal in number, which are both 1 or more in number. In one specific embodiment, each of the locking mechanism 4 and the locking groove 2 is 1 in number.

To enhance a stacking and locking effect of the tool kit, in the groove 1 on the upper surface of the kit body, clamping grooves 21 are provided inside one side opposite to the locking grooves 2; clamping blocks 22 are provided on the edges of the protrusions 3 on the lower surface of the kit body, and the clamping blocks 22 and the clamping grooves 21 are both matched in size and position; and the clamping grooves 21 and the clamping blocks 22 are the same in number and are both more than 2 in number. In one specific embodiment, the clamping grooves 21 and the clamping blocks 22 are both 3 in number and are evenly distributed on one side of the groove 1.

Meanwhile, to facilitate locking and unlocking of the locking mechanisms 4, the locking mechanisms 4 are provided on one side of an opening of the tool kit.

In addition, to facilitate carrying and placement of the tool kit, a handle placement groove 23 is provided in a middle portion of the groove 1, and a foldable handle 24 is provided in the handle placement groove 23; and meanwhile, a cocking groove 25 is provided on a side edge of the tool kit to facilitate carrying and pulling with hands.

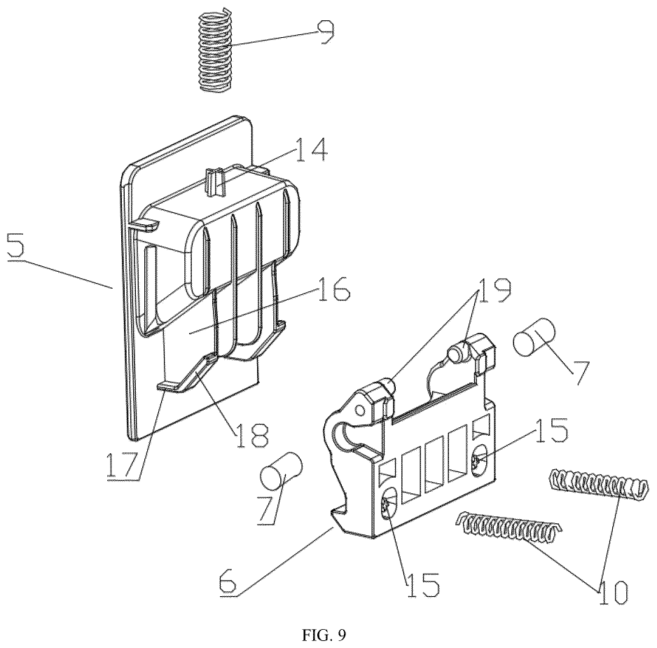

A locked state of stacked tool kits is shown in FIG. 9.

A working principle of the tool kit with locking mechanisms of the present invention is as follows.
1. Stacking and locking of tool kits:

First, the tool kit below is placed at a suitable position, and one side of the tool kit above provided with the clamping blocks 22 is inclined downward to make the clamping blocks 22 clamped into the clamping grooves 21 of the tool kit below.

Then, the tool kit above is placed flat, the locking buckle hooks 8 fall into the groove 1 of the tool kit below, edges of the locking grooves 2 squeeze the locking buckle hooks 8 to compress the second elastic members 10 to shrink, and the locking buckle hooks 8 continuously move downward and fall in the locking grooves 2 for locking, thereby achieving stacking and locking of the tool kits.
2. Unlocking of the tool kits:

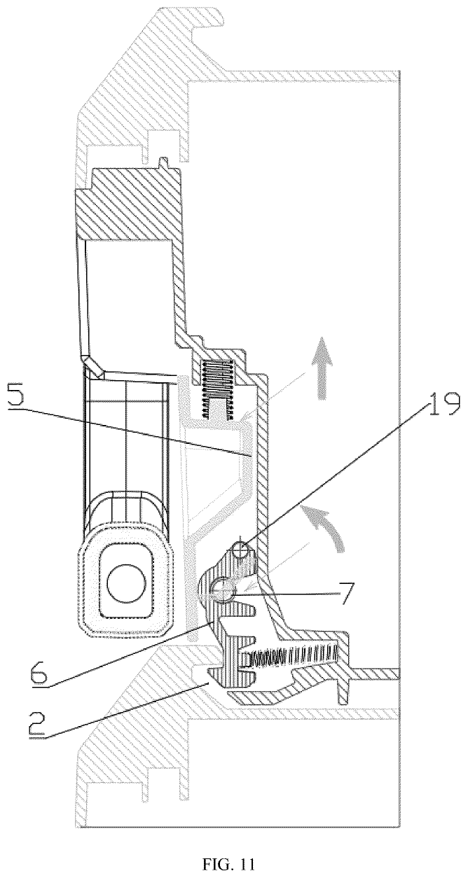

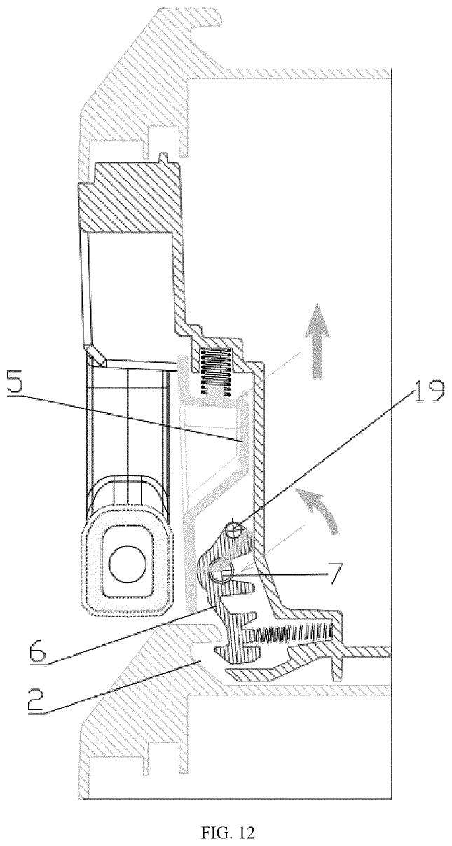

An unlocking process of the stacked tool kits is shown in FIG. 11-FIG. 12.

First, fingers are placed in the push grooves 20 to pull the push grooves 20 upward to drive the unlocking members 5 to move upward relative to positions of the locking fasteners 6, the locking and unlocking shafts 19 move downward in the locking and unlocking portions 16 along positions of the second convex edges 18, the upper portions of the locking fasteners 6 rotate leftward around the rotating shafts 7 under a squeezing action of the back surfaces of the unlocking members 5, the lower portions of the locking fasteners 6 correspondingly rotate rightward around the rotating shafts 7, the second elastic members 10 are squeezed by the second elastic member sleeve columns 15 to move in the second elastic member mounting grooves 13, and the locking buckle hooks 8 are detached from the locking grooves 2.

Then, the tool kit above is lifted upward to make the locking fasteners 6 completely detached from the locking grooves 2. Subsequently, the tool kit above is tilted to make the clamping blocks 22 detached from the clamping grooves 21, thus achieving unlocking of the tool kits.

The above only shows preferred embodiments of the present invention and is not intended to limit the present invention. Any modifications, equivalent substitutions, improvements, and the like that are made within the design concept of the present invention shall be included within the scope of protection of the present invention.

What is claimed is:

1. A tool kit with locking mechanisms, comprising a kit body, wherein locking grooves are provided on one side surface of the kit body, the locking mechanisms are provided on the other side surface of the kit body, and the locking mechanisms comprise unlocking members and locking fasteners that are connected to each other;
when multiple tool kits are stacked and when the unlocking members are in a locked position state, locking fasteners of one of the tool kits are clamped into locking grooves of another one of the tool kits; and when the unlocking members are in an unlocked position state, the locking fasteners of the one of the tool kits are detached from the locking grooves of the another one of the tool kits.

2. The tool kit with locking mechanisms according to claim 1, wherein a groove is provided on an upper surface of the kit body, and locking grooves are provided on edges of the groove; protrusions are provided on a lower surface of the kit body, and sizes of outer side edges of the protrusions are smaller than those of inner side edges of the groove; the locking mechanisms are provided on edges of the protrusions, and the locking fasteners are provided at lower portions of the locking mechanisms; and when multiple tool kits are stacked, in a locked state, protrusions of a tool kit above are placed in a groove of a tool kit below, and locking fasteners of the tool kit above are clamped into locking grooves of the tool kit below.

3. The tool kit with locking mechanisms according to claim 1, wherein the locking mechanisms further comprise rotating shafts, first elastic members, and second elastic members;
locking mechanism mounting grooves are provided on the edges of the protrusions, and first elastic member mounting grooves and second elastic member mounting grooves are provided in the locking mechanism mounting grooves;
first elastic member sleeve columns are provided above the unlocking members, the first elastic members are sleeved on the first elastic member sleeve columns, the first elastic members are movably placed in the first elastic member mounting grooves,
second elastic member sleeve columns are provided on the locking fasteners, the second elastic members are sleeved on the second elastic member sleeve columns, and the second elastic members are movably placed in the second elastic member mounting grooves;
the first elastic member mounting grooves are located above the locking mechanism mounting grooves in a vertical direction, and the second elastic member mounting grooves are located below the locking mechanism mounting grooves in a horizontal direction;
locking and unlocking portions are provided on both left and right side surfaces of the unlocking members, the locking and unlocking portions comprise first convex edges and second convex edges that are provided from bottom to top along the side surfaces of the unlocking members, the first convex edges are horizontally provided, and the second convex edges are obliquely provided upward; areas defined by back surfaces and side surfaces of the unlocking members, the first convex edges, and the second convex edges are the locking and unlocking portions;
inner sides of upper portions of the locking fasteners are clamped and mounted into the locking and unlocking portions through locking and unlocking shafts, outer sides of middle portions of the locking fasteners are rotatably mounted in the locking mechanism mounting grooves through the rotating shafts, and locking buckle hooks are integrally formed at lower portions of the locking fasteners; the locking and unlocking shafts and the rotating shafts are both 2 in number and are each respectively located symmetrically on left and right sides of the locking fasteners; and
the middle portions to the upper portions of the locking fasteners are obliquely provided upward and are consistent with inclination directions of the first convex edges, and distances between the rotating shafts and back surfaces of the locking fasteners are greater than distances between the locking and unlocking shafts and the back surfaces of the locking fasteners.

4. The tool kit with locking mechanisms according to claim 3, wherein front surfaces of the unlocking members are provided with push grooves above the locking and unlocking portions.

5. The tool kit with locking mechanisms according to claim 3, wherein the second elastic member sleeve columns are 2 in number and are respectively located below the 2 locking and unlocking shafts.

6. The tool kit with locking mechanisms according to claim 3, wherein the locking mechanisms and the locking grooves are the same in number and are both 1 or more in number.

7. The tool kit with locking mechanisms according to claim 1, wherein in the groove on the upper surface of the kit body, clamping grooves are provided inside one side opposite to the locking grooves; and clamping blocks are provided on the edges of the protrusions on the lower surface of the kit body, and the clamping blocks and the clamping grooves are both matched in size and position.

8. The tool kit with locking mechanisms according to claim 7, wherein the clamping grooves and the clamping blocks are the same in number and are both more than 2 in number.

9. The tool kit with locking mechanisms according to claim 1, wherein the locking mechanisms are located on one side of an opening of the tool kit.

10. The tool kit with locking mechanisms according to claim 1, wherein a cocking groove is provided on a side edge of the tool kit. The lamp cap connecting structure with stable connection according to claim 1, wherein both sides of the top of the main body of the connecting piece II are provided with buckles III symmetrically; correspondingly, the connecting piece I is provided with clamping grooves; and during assembling, the buckles III are located in the clamping grooves.
